(19) United States
(12) Patent Application Publication
(10) Pub. No.: US 2026/0128784 A1
(43) Pub. Date: May 7, 2026

(54) APPARATUSES AND METHODS FOR FACILITATING A UNIVERSAL, WORLDWIDE DATABASE WITH INTEGRATED SATELLITE CONSTELLATION COVERAGE

(71) Applicant: AT&T Intellectual Property I, L.P., Atlanta, GA (US)

(72) Inventors: Adrian Moore, Coppell, TX (US); Venson Shaw, Kirkland, WA (US)

(73) Assignee: AT&T Intellectual Property I, L.P., Atlanta, GA (US)

(21) Appl. No.: 18/939,568

(22) Filed: Nov. 7, 2024

(51) Int. Cl. H04B 7/185; H04B 7/195; H04W 72/02; H04W 84/06

(52) U.S. Cl. CPC H04B 7/18539; H04B 7/195; H04W 72/02; H04W 84/06

(57) ABSTRACT

Aspects of the subject disclosure may include, for example, predicting an amount of demand for a communication service, based on the predicting, determining that a communication bandwidth available via a first base station of a first network is unable to satisfy the amount of demand, based on the determining, scheduling a first satellite of a constellation of satellites to provide at least a portion of the communication service, resulting in a schedule, and providing the at least a portion of the communication service in accordance with the schedule. Other embodiments are disclosed.

### FIELD OF THE DISCLOSURE

The subject disclosure relates to apparatuses and methods for facilitating a universal, worldwide database with integrated satellite constellation coverage.

### BACKGROUND

Vast communication networks and systems, and a variety of communication services, may be utilized in provisioning communication services. Fifth Generation (5G) technology has increased over the last several years due to the increased bandwidth capabilities being delivered, lower latencies and other capabilities like bandwidth slicing. Most of the increase is attributed to end users in urban markets that are typically densely populated, and the economics of scale are favorable to justify the investment associated with the infrastructure needed to support 5G. However, in rural environments, the decision as to whether to invest in infrastructure can be a challenging, as the economics of scale often do not make it conducive for a service provider to provide higher speed bandwidth offerings delivered with 5G to less densely populated areas.

Cost is the primary detractor for expanding 5G, as installing 5G infrastructure can be an expensive endeavor. It is not cost effective to build-out a network/system to support a limited amount of subscribers that are more spread out and require more towers to serve them relative to urban locations. In addition, in rural areas the terrain can also be an issue where there are often more natural obstructions limiting the propagation capabilities of antennas, making it difficult to reliably receive a wireless signal. Given the increased infrastructure costs and the propagation limitations associated with 5G that require more densely populated small cells, a Fourth Generation (4G) or 4G Non-Standalone (NSA) configuration may be more advantageous for rural applications/environments. The coverage for 4G or 4G Long Term Evolution (LTE) can range for 10 to 20 miles, in comparison to 5G which can span up to 1000 feet. Thus, speed-tier offerings in rural or remote applications are extremely low/limited.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system in accordance with various aspects described herein.

FIG. 2B depicts an illustrative embodiment of a method in accordance with various aspects described herein.

FIG. 2C depicts a viewing radius associated with an antenna and a satellite in accordance with aspects of this disclosure.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for scheduling resources associated with communication networks and systems based on a forecast/prediction of demand for the resources (or, analogously, demand for communication services) and an accessibility/availability of the resources. In some embodiments, availability/accessibility of a resource may be expressed in terms of an arrival time and/or a departure time of the resource relative to a viewing radius of an antenna. Other embodiments are described in the subject disclosure.

One or more aspects of the subject disclosure include, in whole or in part, identifying a communication service in association with a user equipment, resulting in a first identification; determining, based on the first identification, that a first amount of bandwidth available to the user equipment via a first resource of a terrestrial network is less than a first threshold, resulting in a first determination; selecting, based on the first determination, a resource of a non-terrestrial network (NTN), resulting in a first selected resource of the NTN; and provisioning a first portion of the communication service to the user equipment via the first selected resource of the NTN.

One or more aspects of the subject disclosure include, in whole or in part, predicting an amount of demand for a communication service; based on the predicting, determining that a communication bandwidth available via a first base station of a first network is unable to satisfy the amount of demand; based on the determining, scheduling a first satellite of a constellation of satellites to provide at least a portion of the communication service, resulting in a schedule; and providing the at least a portion of the communication service in accordance with the schedule.

One or more aspects of the subject disclosure include, in whole or in part, determining, by a processing system including a processor, a respective arrival time of each satellite included in a plurality of satellites relative to a viewing radius of a first antenna associated with a first base station of a terrestrial network, resulting in a first determination; determining, by the processing system, a respective departure time of each satellite included in the plurality of satellites relative to the viewing radius of the first antenna, resulting in a second determination; generating, by the processing system, a forecast of demand for communication services amongst a plurality of communication devices; and scheduling, by the processing system, a utilization of at least one satellite included in the plurality of satellites based on the first determination, the second determination, and the forecast.

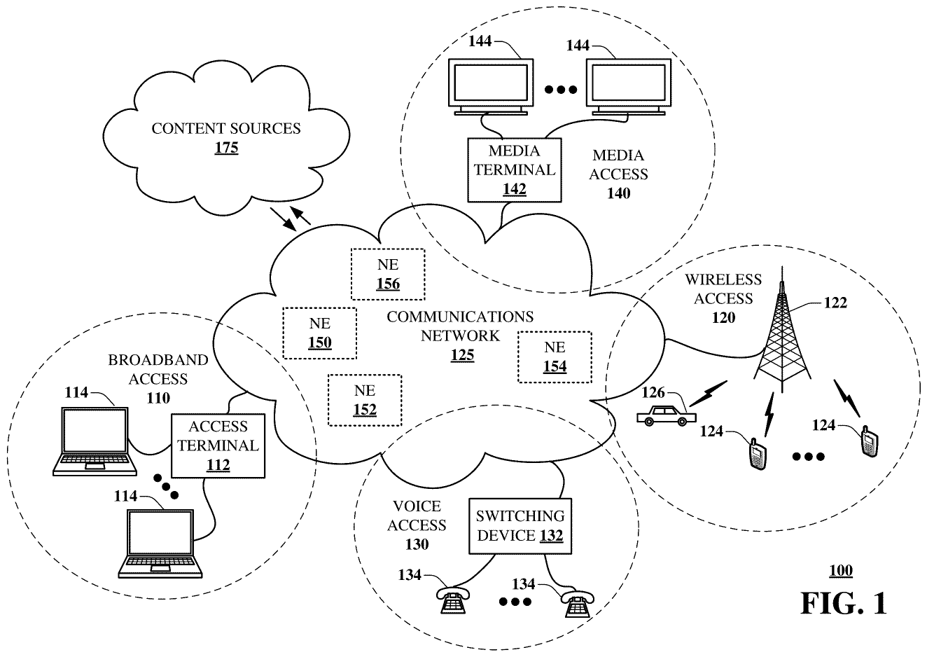

Referring now to FIG. 1, a block diagram is shown illustrating an example, non-limiting embodiment of a system 100 in accordance with various aspects described herein. For example, the system 100 can facilitate, in whole or in part, identifying a communication service in association with a user equipment, resulting in a first identification, determining, based on the first identification, that a first amount of bandwidth available to the user equipment via a first resource of a terrestrial network is less than a first threshold, resulting in a first determination, selecting, based on the first determination, a resource of a non-terrestrial network (NTN), resulting in a first selected resource of the NTN, and provisioning a first portion of the communication service to the user equipment via the first selected resource of the NTN. The system 100 can facilitate, in whole or in part, predicting an amount of demand for a communication service, based on the predicting, determining that a communication bandwidth available via a first base station of a first network is unable to satisfy the amount of demand, based on the determining, scheduling a first satellite of a constellation of satellites to provide at least a portion of the communication service, resulting in a schedule, and providing the at least a portion of the communication service in accordance with the schedule. The system 100 can facilitate, in whole or in part, determining, by a processing system including a processor, a respective arrival time of each satellite included in a plurality of satellites relative to a viewing radius of a first antenna associated with a first base station of a terrestrial network, resulting in a first determination, determining, by the processing system, a respective departure time of each satellite included in the plurality of satellites relative to the viewing radius of the first antenna, resulting in a second determination, generating, by the processing system, a forecast of demand for communication services amongst a plurality of communication devices, and scheduling, by the processing system, a utilization of at least one satellite included in the plurality of satellites based on the first determination, the second determination, and the forecast.

In particular, in FIG. 1 a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

By way of introduction, aspects of this disclosure may leverage a global satellite map that may be used in conjunction with a (n intelligent) tower, antenna or base station (e.g., eNodeB) to have knowledge of when satellites (e.g., low earth orbit (LEO) satellites) in a constellation will be in that antenna's viewing radius/coverage to remain in a 5G Non-Standalone (NSA) configuration. The base station may include software that may leverage Open application programming interfaces (APIs) exposed/accessible via a radio access network (RAN) intelligent controller, where such a controller may include a software-defined component or element tied to the Open RAN (ORAN) architecture. The base station, having knowledge of the global footprint of satellites available to it, may leverage a predicative analysis via the exposed APIs as part of, e.g., service management and orchestration (SMO) functionality, and may leverage a RAN intelligent controller (RIC), to incorporate predictive analysis as to when specific satellites will arrive in the base station's/antenna's viewing radius and when the satellites will leave/depart that viewing radius. This predictive analysis may be leveraged in conjunction with a traffic scheduler so that non-critical traffic can be scheduled or queued for delivery based upon the arrival and/or departure of a satellite, or if additional bandwidth is needed to overcome a bandwidth deficit the net effective bandwidth that is available may be increased when, e.g., a 5G capable satellite arrives to join in a 5G NSA configuration. These capabilities may be included as part of the ORAN architecture, where application development to define the policies and performance metrics using artificial intelligence (AI) and/or machine learning (ML) to invoke changes (e.g., real-time changes) on the RAN intelligent controller may be utilized or supported.

LEO satellites may be in motion as they orbit Earth. It may be the case that individual satellites can only cover small areas/regions of Earth as they pass over a base station's/antenna's viewing radius given their proximity to the Earth's orbit. This is why LEO satellites are frequently deployed in constellations—to enhance coverage. Satellite constellations can range from several hundred satellites to upwards of thousands of satellites. Many satellite constellations rely on communications between each satellite and a base station/antenna, which communications are sometimes intermittent. Given that the satellites are frequently moving within the constellation, each satellite might only have visibility to a base station or antenna (in respect of the aforementioned viewing radius) for a limited period of time. Further, once the satellite has left the viewing radius of the base station/antenna the satellite typically must establish connectivity with another satellite to remain in a 5G NSA configuration.

There are several issues with maintaining communication with LEO satellites that must be overcome to ensure that the base station/antenna can leverage the satellite in a 5G NSA configuration. Given how quickly LEO satellites move, a base station/antenna must be able to perform a number of functions, e.g., acquire the satellite's signal, track the satellite's path, and convey/exchange as much data with the satellite as possible. In addition, with the number of satellites flying within a constellation, antennas must be able to communicate through transfers from one satellite to the next. If communication is dropped/lost, this may present complications/complexities in terms of remaining in a 5G NSA configuration.

Given that base stations/antennas typically only have a few seconds to perform the aforementioned functions, dropped communications may occur with some regularity. Dropped communications can be problematic for applications/services that are sensitive to latency (or operate within a latency budget), such as voice, video or specific point of sale (POS) applications. To address these and other challenges, aspects of this disclosure may leverage a Global Positioning System (GPS) database, or the like, with coordinates and path-of-travel information/data for various satellites/satellite constellations. The intelligent base station, using the exposed RIC APIs made available via the ORAN architecture, may have the ability to leverage the database and determine when an available satellite will be in a particular viewing radius of its antenna. Given that the base station will have knowledge as to when a satellite will be located within its viewing radius, traffic can be scheduled to be delivered when additional bandwidth is available once the satellite can be leveraged in a 5G NSA configuration. The base station, armed with an application (e.g., xApp) solution-which may be referred to herein generally as a traffic scheduler—may utilize AI and/or ML to develop historical predictive analyses and develop a time-dependent satellite route and traffic map or plan where the base station may know at what specific days or times satellites can be joined/utilized. The developed plan may aid in eliminating the need for constant communication to satellites in the constellation, when bandwidth is not needed. Such aspects may lower a noise floor in respect of signaling involving the base station and/or satellites, and reduce (e.g., eliminate) unnecessary communication involving the satellites.

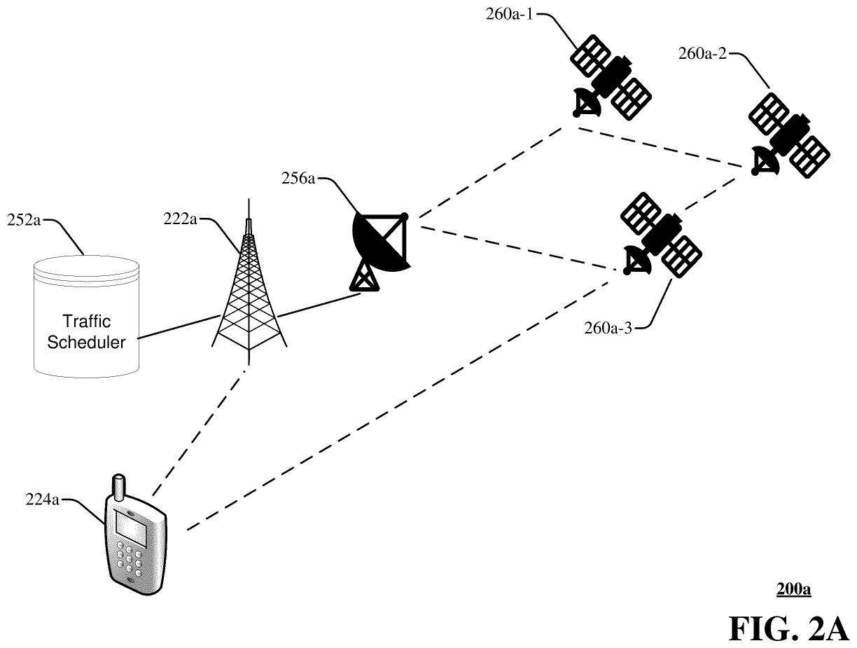

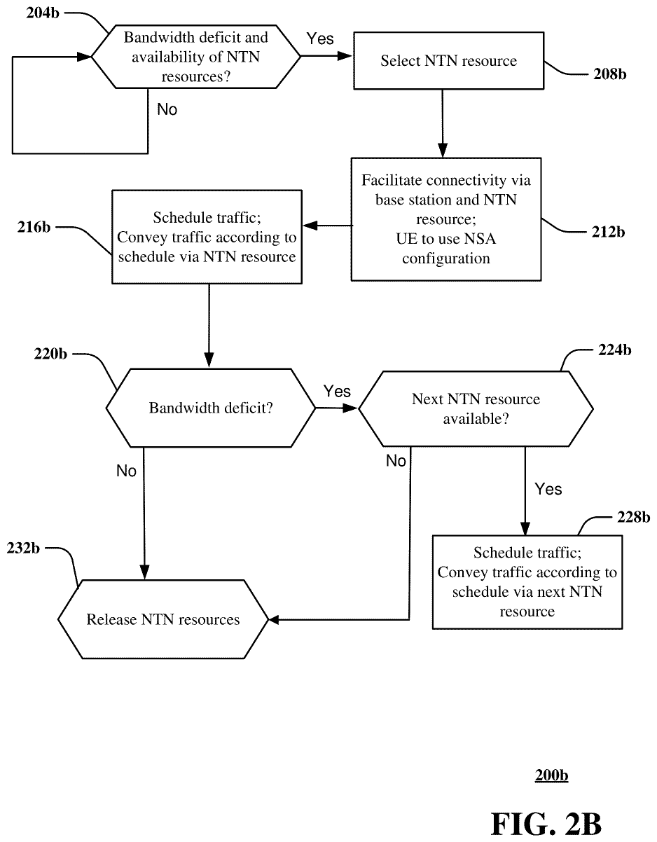

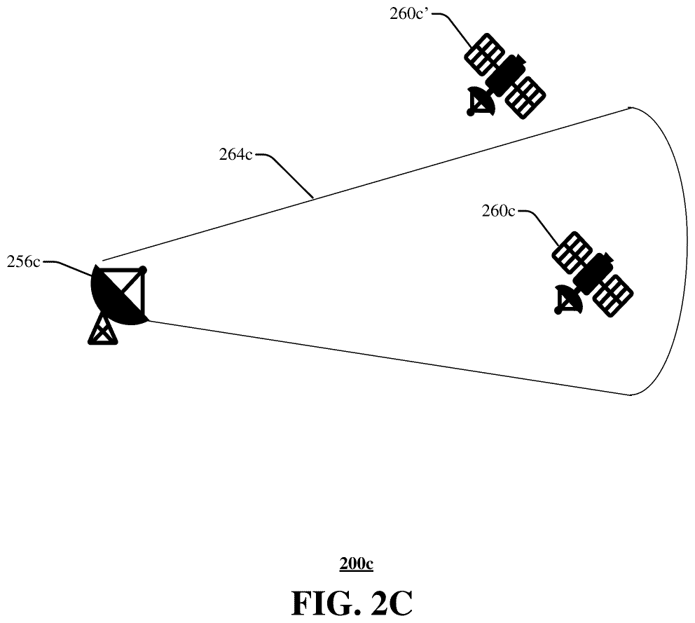

With the foregoing in mind, reference may now be made to FIG. 2A, which depicts a block diagram of an example, non-limiting embodiment of a system 200a in accordance with various aspects described herein. In some embodiments, one or more parts/portions of the system 200a may be combined with, or operatively overlaid upon, one or more parts/portions of the system 100 of FIG. 1.

The system 200a may include a base station or tower (depicted via reference character 222a in FIG. 2A) that may be used to facilitate communication services with respect to a user equipment (UE) 224a. The base station 222a may leverage a traffic scheduler 252a of a type/kind described above. Further, the base station 222a may leverage resources of a non-terrestrial network (NTN), represented as a number of satellites—e.g., a first satellite 260a-1, a second satellite 260a-2, and a third satellite 260a-3. The base station 222a may be associated with/utilize a satellite dish/antenna 256a for interfacing to/with one or more of the satellites 260a-1 through 260a-3. Taken collectively, the satellites 260a-1, 260a-2, and 260a-3 may form a (satellite) constellation. While three satellites are shown in FIG. 2A, in practice there may be hundreds or even thousands of satellites in a given constellation. Communications amongst the various entities shown in FIG. 2A may occur via one or more channels, links, mediums, or the like.

As referenced above, given that the satellites 260a-1, 260a-2, and 260a-3 may be in motion within the constellation, each satellite may only have visibility to the base station 222a for a very limited period of time. Once a given satellite (e.g., satellite 260a-1) has left/departed the viewing radius of the base station 222a (or satellite dish/antenna 256a) the satellite may be required to establish connectivity with another satellite (e.g., the satellite 260a-2) to remain in a 5G NSA configuration. There are several issues with the base station/antenna maintaining communication with LEO satellites that must be overcome to ensure that the base station/antenna can leverage the satellite in a 5G NSA configuration. As set forth above, given how quickly LEO satellites move, an antenna may need to acquire the satellite's signal, track the satellite's path, and upload or download as much data as possible in a short amount of time. In addition, with a large number of satellites potentially being included within a given constellation, antennas may need to communicate through transfers from one satellite to the next; if communication is intermittent, this may pose a problem with the infrastructure/resources (e.g., the base station) remaining in a 5G NSA configuration.

To address the foregoing, a global satellite map may be leveraged as part of various embodiments of this disclosure. The map may be used in conjunction with/by a base station (or associated antenna) to have knowledge of when satellites (e.g., LEO satellites) of a constellation will be in that base station's/antenna's viewing radius to remain in a 5G NSA configuration. The base station, having knowledge of the global footprint of the satellites, may determine/identify when specific satellites arrive and when the specific satellites leave/depart in terms of the viewing radius. Predictive, historical analyses may be leveraged in conjunction with the traffic scheduler so that non-critical traffic can be scheduled or queued for delivery based upon the arrival of a satellite, or if additional bandwidth is needed bandwidth can be increased when a satellite arrives within the viewing radius. Historical data captured by the base station may be used to configure a satellite route plan that can be used as a preferred route or route plan for base station communication with satellites that will be within the viewing radius. With reference to FIG. 2C, a (portion of a) system 200c is shown, whereby a satellite dish/antenna 256c (which may correspond to the satellite dish/antenna 256a of FIG. 2A) is shown with respect to a viewing radius 264c superimposed. At a particular time instant shown in FIG. 2C, a satellite 260c is within the viewing radius 264c; thereafter, at a later time the satellite 260c may have moved as fairly represented by the reference character 260c′. At the position represented by the reference character 260c′, the satellite may be outside of the viewing radius 264c. Aspects of this disclosure may leverage a schedule of when the satellite 260c (or another satellite) is located within the viewing radius 264c to facilitate a conveyance of data/information as described in further detail below.

Referring now to FIG. 2B, an illustrative embodiment of a method 200b in accordance with various aspects described herein is shown. The method 200b may be implemented or executed, in whole or in part, in conjunction with one or more systems, devices, and/or components, such as for example the systems, devices, and components described herein. In some embodiments, aspects of the method 200b may be utilized in connection with one or more processing systems. Various operations of the method 200b are described below in relation to the blocks shown in FIG. 2B.

In block 204b, a determination may be made whether there is a bandwidth deficit (which may be expressed relative to a threshold and/or as a function of an application or service) that is being experienced by a communication device (e.g., a UE), and whether there is/are one or more resources available via a non-terrestrial network (NTN), such as a satellite network. As used in the context of block 204b, a bandwidth deficit may refer to an inability of a network/system operator or service provider to furnish sufficient bandwidth to meet a specification or requirement pertaining to, e.g., quality of service (QoS) or quality of experience (QoE), via resources of a first network or system (e.g., a terrestrial network/system). Assuming that the determination is answered in the affirmative, flow may proceed to block 208b; otherwise, flow may remain at block 204b.

In block 208b, a resource of the NTN may be selected. The selection of block 208b may be based on one or more factors or conditions, such as an identification/determination of locations (on an absolute or relative basis) of NTN resources, an amount of respective load/traffic and/or capacity of the resources of the NTN, capabilities of the resources of the NTN, connection availability, carrier to noise ratio, received signal strength, throughput, packet round trip delay, bit error rate, sector (cell) capacity, bandwidth capacity, data link integrity and reliability, security, etc., or any combination thereof. In some embodiments, the factors/conditions may be weighted and/or scored to facilitate the selection of block 208b; for example, the highest score amongst the scores may be utilized to select the resource corresponding the highest score. As part of block 208b, the selection may be based on one or more negotiations involving a resource of the first network/system (e.g., the terrestrial network/system) and/or negotiations amongst the resources (e.g., satellites) of the NTN.

In block 212b, connectivity/access to communication services may be facilitated via a resource (e.g., a base station) of first network/system and may utilize the resource of the NTN selected as part of block 208b. For example, as part of block 212b the selected resource of the NTN may assume the role of 5G New Radio (NR) node, where the resource (e.g., base station) of first network/system may assume a role of primary/master (potentially leveraging 4G LTE technology) and the resource (e.g., satellite) of the NTN may assume a role as a secondary/slave. As part of block 212b, the communication device (e.g., the UE) may be commanded/configured to utilize a 5G NSA configuration.

In block 216b, traffic involving the communication device (e.g., the UE) may be scheduled, potentially via the traffic scheduler described above. In some embodiments, the scheduling of block 216b may provide priority to non-critical traffic involving the communication device, so as to not hinder any specific type or kind of traffic (generally speaking, critical traffic may be conveyed via a use of the resources of the first/terrestrial network/system). One or more bands (e.g., the Ka band) may be utilized as part of communications/signaling associated with the block 216b.

The flow from block 216b to block 220b shown in FIG. 2B may be based on a determination that the selected resource (of block 208b) of the NTN might no longer be able to support communications involving the communication device (e.g., the UE). For example, it may be the case that the selected resource of the NTN: is about to depart the viewing radius of the resource (e.g., the base station or associated antenna) of the first network/system (e.g., the terrestrial network/system), is overloaded (e.g., is accommodating load in an amount that exceeds a threshold), has become (partially) inoperable, etc.

In block 220b, a determination may be made whether the communication device (e.g., the UE) is still operating in a condition of a bandwidth deficit. If so, flow may proceed from block 220b to block 224b; otherwise, flow may proceed from block 220b to block 232b.

In block 224b, a determination may be made whether there is another or next resource available within the NTN to support communications involving the communication device. The determination of block 224b may be based on one or more factors or conditions, such as for example the types of factors/conditions described above in respect of the selection of block 208b. If the determination of block 224b is answered in the affirmative, flow may proceed from block 224b to block 228b; otherwise, flow may proceed to block 232b.

In block 228b, traffic involving the communication device may be scheduled in view of the utilization of the next NTN resource (of block 224b). Block 228b may include a handover/conveyance of traffic (and potentially state or control information associated with any communication session) from the selected NTN resource (of block 208b) to the next NTN resource (of block 224b). The scheduled traffic may be conveyed utilizing the next NTN resource as part of block 228b.

Aspects of the blocks 204b through 228b may be executed iteratively or repeatedly to account for changes in conditions or circumstances. In the context of fast-moving resources (e.g., satellites) of an NTN network/system, aspects of the blocks 204b and 228b may be utilized to select the network resource of the NTN network/system in turn, at least up until the point that no such resource of an NTN network/system is available or until the demand for resources (e.g., bandwidth) on the part of the communication device (e.g., the UE) has cased/relaxed. Block 232b may provide for a release of one or more NTN resources (to a pool of NTN resources) when no such resource of an NTN network/system is available or when the demand for resources (e.g., bandwidth) on the part of the communication device (e.g., the UE) has cased/relaxed (as potentially expressed relative to one or more thresholds). Block 232b may include reconfiguring the communication device (e.g., the UE) to no longer utilize a (5G) NSA configuration.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. One or more blocks or operations may be based on one or more other blocks or operations.

As described above, a base station (which may utilize or leverage a near real-time RIC), in conjunction with a traffic scheduler (which may utilize or leverage a near real-time RIC), may be equipped/configured to gather historical traffic analyses. These analyses may be leveraged to create/generate a satellite route and traffic plan, which may include indications of traffic demand/load (actual or anticipated) being placed on the base station. In some embodiments, the expression of demand may be parameterized in terms of, e.g., direction (uplink, downlink), plane type (user plane, control plane), etc. Historical traffic analyses may be gathered pursuant to a schedule, for a user-defined duration, for some specific sampling period, or otherwise.

Once the historical traffic analyses are captured/obtained, the base station/traffic scheduler may leverage AI and/or ML to perform a predictive analysis to determine when bandwidth deficits are likely occur on, e.g., a hourly basis over a 24-hour period. This will equip the bases station/traffic scheduler to leverage, e.g., an LEO satellite global coordinate map database to have a view of the global footprint of LEO satellites and when the LEO Satellites will enter/arrive and leave/depart a base station's/antenna's viewing radius. This information may be used to create a satellite route plan for the base station that will aid in the creation/generation of satellite route and traffic map, which in turn may be used to schedule a conveyance of communications or signals associated with one or more communication services, communication devices, etc.

Coupled with the historical traffic analyses, the predictive analysis may be used to develop a satellite route and traffic plan pertaining to when specific satellites will arrive in the base station/antenna's viewing radius and when those satellites will leave/depart the base station/antenna's viewing radius, in conjunction with where bandwidth deficits will have a high probability of occurring. Once the satellite route and traffic plan are created/generated, the base station may join the specific satellites identified within the satellite route and traffic map at the designated time when the traffic deficit is likely to occur. In this manner, a network/system operator or service provider may make efficient use of scarce resources as part of provisioning communication services.

As set forth above, aspects of this disclosure may be utilized to achieve high-valued quality of service (QoS) or quality of experience (QoE) in respect of provisioning of community services. As described above, in some environments (e.g., rural environments) it might not be practical or economically feasible to deploy infrastructure (e.g., base stations, towers, etc.) to support a limited or reduced subscriber base. In some instances (such as during a natural disaster), it may be the case that there may be an outage or inoperability associated with resources of a terrestrial network/system. Aspects of this disclosure may be used to extend services to such environments or instances/occurrences via a utilization of mobile resources (e.g., satellite resources of an NTN).

Thus, in accordance with the foregoing, practical applications of the various aspects of this disclosure may be utilized to determine/identify resources of a secondary network/system (e.g., a NTN) that may be used to supplement resources of a primary network/system (e.g., a terrestrial network/system). In particular, such applications may include/provide a tailored route and traffic map specific for a base station (or other resource) which may alleviate the intermittent communications/signaling experienced in the past. Thus, aspects of this disclosure represent substantial improvements to technology as manifested/represented in the quality and reliability of communications and signaling that are obtained. In addition, aspects of this disclosure may reduce or eliminate any unnecessary communication in, e.g., the uplink direction when there is not a bandwidth need for the base station to be configured in a 5G NSA configuration. Further, by equipping each base station with a respective, tailored plan that predictively targets those specific satellites that will be in the base station's/antenna's viewing radius at specified times and in conjunction with when bandwidth demands (exceeding a threshold) are expected to occur, overhead communications/signaling may be greatly reduced and the noise floor being experienced across a satellite constellation can be further reduced, which can promote a reduction (e.g., an elimination) of intermittent communications.

Aspects of this disclosure may make efficient and timely use of resources associated with one or more communication networks or systems in a provisioning of communication services. Various features may be leveraged as part of practical applications involving a provisioning of communication services, particularly in relation to provisioning communication services in remote or rural environments where a pool of available subscribers is typically small and the cost of deploying (terrestrial) infrastructure is large.

As one skilled in the art will appreciate, LEO satellites are frequently in motion as they orbit Earth; individual LEO satellites can only cover small areas of Earth as they pass over/within a base station/antenna's viewing radius. This is why LEO satellites are deployed in constellations—to enhance coverage. Many satellite constellations have thousands of nodes and rely on communications between each satellite and a terrestrial base station. These communications need to be reliable for operations to be effective. Given the amount of satellites in a constellation, the speed at which the satellites move, and the close proximity of the satellites to the Earth, conventionally such a setup leads to intermittent communications. Aspects of this disclosure address such intermittent communications as part of mapping and planning operations in respect of the locations of the satellites and expected or anticipated demand/load.

Various aspects of this disclosure may extend principles of standards and concepts associated with an ORAN to NTN technologies. For example, signaling or communications involving one or more planes (e.g., control planes, user planes) may be extended to NTN technologies. In some embodiments, resources (e.g., satellites) of an NTN may be controlled or managed to provide access to communication services (or portions thereof). For example, in some embodiments a command or control may be directed to a satellite to move in a particular direction, at a given speed or velocity, at a given acceleration, etc.

Resource allocation decisions or determinations may be based on one or more predictive models or algorithms. For example, in the context of an event occurring at a stadium, it may be the case that prior to the start of the event demand (for, e.g., bandwidth) in a downlink direction proximal to the stadium may exceed a norm or threshold (e.g., as users download audio or video associated with the event or associated with a person appearing at the event). Conversely, once the event has started, it may be the case that demand (for, e.g., bandwidth) in the uplink direction may exceed a norm or threshold (e.g., as users share videos or images of the event). Aspects of this disclosure may be used to determine/identify patterns in demand and adjust a utilization of resources in accordance therewith.

Conventionally, resources of an NTN may be used to supplement resources of a terrestrial network/system. Aspects of this disclosure may effectively flip that relationship on its head, whereby resources of the NTN may effectively become the “default” and resources of the terrestrial network/system may supplement the resources of the NTN. In this regard, aspects of this disclosure may effectively pool resources of multiple networks or systems to achieve particular objectives or purposes in provisioning communication services.

In brief, one skilled in the art will appreciate based on a review of this disclosure that the various aspects of this disclosure are not directed to abstract ideas. To the contrary, the various aspects of this disclosure are directed to, and encompass, significantly more than any abstract idea standing alone. Indeed, the various aspects of this disclosure have been demonstrated herein to provide useful, concrete, and tangible results as part of numerous practical applications involving substantial improvements to technology. Such improvements may be quantified or qualified in terms of a reduction in signaling, a reduction in power consumption/dissipation, enhanced qualities and reliabilities in communications/signaling, etc. As such, the various aspects of this disclosure are transformative in nature and are representative of a major paradigm shift in provisioning communication services.

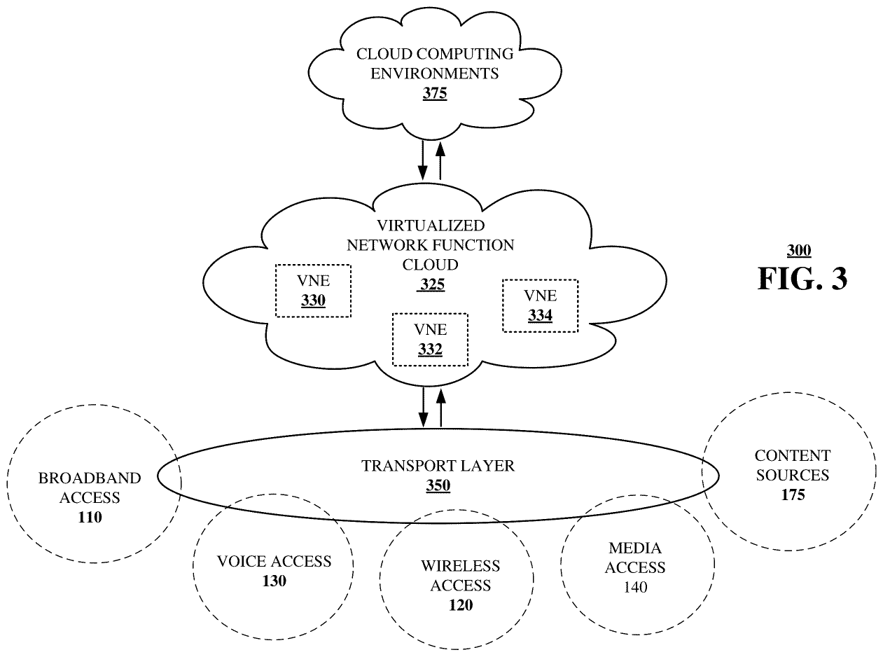

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200a, and method 200b presented in FIGS. 1, 2A, and 2B. For example, the virtualized communication network 300 can facilitate, in whole or in part, identifying a communication service in association with a user equipment, resulting in a first identification, determining, based on the first identification, that a first amount of bandwidth available to the user equipment via a first resource of a terrestrial network is less than a first threshold, resulting in a first determination, selecting, based on the first determination, a resource of a non-terrestrial network (NTN), resulting in a first selected resource of the NTN, and provisioning a first portion of the communication service to the user equipment via the first selected resource of the NTN. The virtualized communication network 300 can facilitate, in whole or in part, predicting an amount of demand for a communication service, based on the predicting, determining that a communication bandwidth available via a first base station of a first network is unable to satisfy the amount of demand, based on the determining, scheduling a first satellite of a constellation of satellites to provide at least a portion of the communication service, resulting in a schedule, and providing the at least a portion of the communication service in accordance with the schedule. The virtualized communication network 300 can facilitate, in whole or in part, determining, by a processing system including a processor, a respective arrival time of each satellite included in a plurality of satellites relative to a viewing radius of a first antenna associated with a first base station of a terrestrial network, resulting in a first determination, determining, by the processing system, a respective departure time of each satellite included in the plurality of satellites relative to the viewing radius of the first antenna, resulting in a second determination, generating, by the processing system, a forecast of demand for communication services amongst a plurality of communication devices, and scheduling, by the processing system, a utilization of at least one satellite included in the plurality of satellites based on the first determination, the second determination, and the forecast.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure casier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

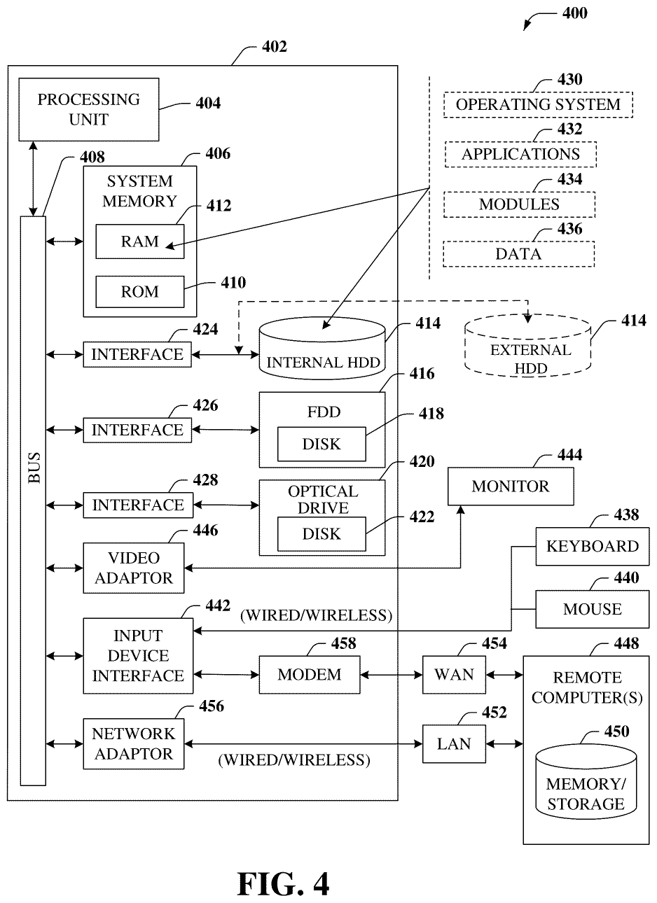

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, the computing environment 400 can facilitate, in whole or in part, identifying a communication service in association with a user equipment, resulting in a first identification, determining, based on the first identification, that a first amount of bandwidth available to the user equipment via a first resource of a terrestrial network is less than a first threshold, resulting in a first determination, selecting, based on the first determination, a resource of a non-terrestrial network (NTN), resulting in a first selected resource of the NTN, and provisioning a first portion of the communication service to the user equipment via the first selected resource of the NTN. The computing environment 400 can facilitate, in whole or in part, predicting an amount of demand for a communication service, based on the predicting, determining that a communication bandwidth available via a first base station of a first network is unable to satisfy the amount of demand, based on the determining, scheduling a first satellite of a constellation of satellites to provide at least a portion of the communication service, resulting in a schedule, and providing the at least a portion of the communication service in accordance with the schedule. The computing environment 400 can facilitate, in whole or in part, determining, by a processing system including a processor, a respective arrival time of each satellite included in a plurality of satellites relative to a viewing radius of a first antenna associated with a first base station of a terrestrial network, resulting in a first determination, determining, by the processing system, a respective departure time of each satellite included in the plurality of satellites relative to the viewing radius of the first antenna, resulting in a second determination, generating, by the processing system, a forecast of demand for communication services amongst a plurality of communication devices, and scheduling, by the processing system, a utilization of at least one satellite included in the plurality of satellites based on the first determination, the second determination, and the forecast.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

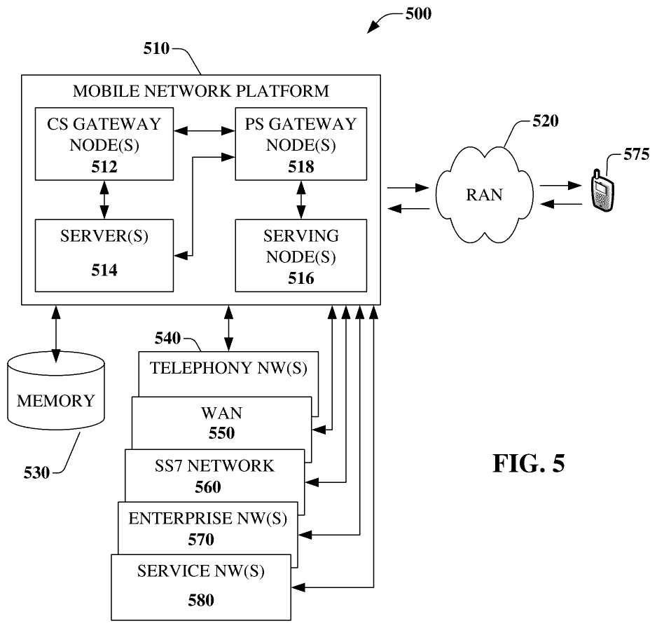

Turning now to FIG. 5, an embodiment 500 of a mobile network platform 510 is shown that is an example of network elements 150, 152, 154, 156, and/or VNEs 330, 332, 334, etc. For example, the platform 510 can facilitate, in whole or in part, identifying a communication service in association with a user equipment, resulting in a first identification, determining, based on the first identification, that a first amount of bandwidth available to the user equipment via a first resource of a terrestrial network is less than a first threshold, resulting in a first determination, selecting, based on the first determination, a resource of a non-terrestrial network (NTN), resulting in a first selected resource of the NTN, and provisioning a first portion of the communication service to the user equipment via the first selected resource of the NTN. The platform 510 can facilitate, in whole or in part, predicting an amount of demand for a communication service, based on the predicting, determining that a communication bandwidth available via a first base station of a first network is unable to satisfy the amount of demand, based on the determining, scheduling a first satellite of a constellation of satellites to provide at least a portion of the communication service, resulting in a schedule, and providing the at least a portion of the communication service in accordance with the schedule. The platform 510 can facilitate, in whole or in part, determining, by a processing system including a processor, a respective arrival time of each satellite included in a plurality of satellites relative to a viewing radius of a first antenna associated with a first base station of a terrestrial network, resulting in a first determination, determining, by the processing system, a respective departure time of each satellite included in the plurality of satellites relative to the viewing radius of the first antenna, resulting in a second determination, generating, by the processing system, a forecast of demand for communication services amongst a plurality of communication devices, and scheduling, by the processing system, a utilization of at least one satellite included in the plurality of satellites based on the first determination, the second determination, and the forecast.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology (ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

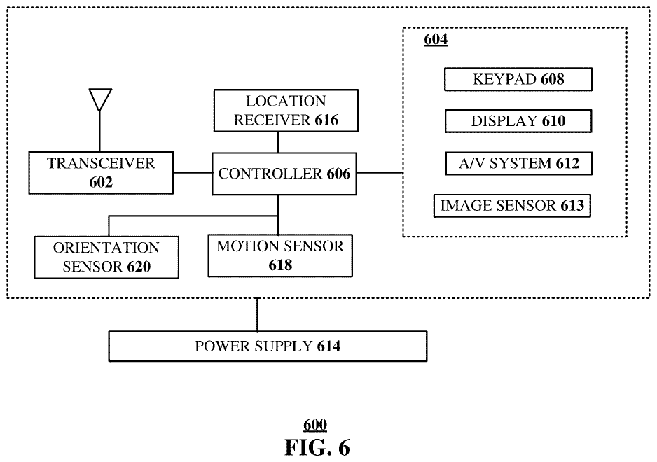

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, the computing device 600 can facilitate, in whole or in part, identifying a communication service in association with a user equipment, resulting in a first identification, determining, based on the first identification, that a first amount of bandwidth available to the user equipment via a first resource of a terrestrial network is less than a first threshold, resulting in a first determination, selecting, based on the first determination, a resource of a non-terrestrial network (NTN), resulting in a first selected resource of the NTN, and provisioning a first portion of the communication service to the user equipment via the first selected resource of the NTN. The computing device 600 can facilitate, in whole or in part, predicting an amount of demand for a communication service, based on the predicting, determining that a communication bandwidth available via a first base station of a first network is unable to satisfy the amount of demand, based on the determining, scheduling a first satellite of a constellation of satellites to provide at least a portion of the communication service, resulting in a schedule, and providing the at least a portion of the communication service in accordance with the schedule. The computing device 600 can facilitate, in whole or in part, determining, by a processing system including a processor, a respective arrival time of each satellite included in a plurality of satellites relative to a viewing radius of a first antenna associated with a first base station of a terrestrial network, resulting in a first determination, determining, by the processing system, a respective departure time of each satellite included in the plurality of satellites relative to the viewing radius of the first antenna, resulting in a second determination, generating, by the processing system, a forecast of demand for communication services amongst a plurality of communication devices, and scheduling, by the processing system, a utilization of at least one satellite included in the plurality of satellites based on the first determination, the second determination, and the forecast.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBec®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, X=(x₁, x₂, x₃, x₄ . . . xₙ), to a confidence that the input belongs to a class, that is, f (x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
identifying a communication service in association with a user equipment, resulting in a first identification;
determining, based on the first identification, that a first amount of bandwidth available to the user equipment via a first resource of a terrestrial network is less than a first threshold, resulting in a first determination;
selecting, based on the first determination, a resource of a non-terrestrial network (NTN), resulting in a first selected resource of the NTN; and
provisioning a first portion of the communication service to the user equipment via the first selected resource of the NTN.

2. The device of claim 1, wherein the operations further comprise:
provisioning a second portion of the communication service to the user equipment via the first resource.

3. The device of claim 2, wherein the provisioning of the first portion of the communication service utilizes Fifth Generation (5G) New Radio (NR) technology.

4. The device of claim 3, wherein the provisioning of the second portion of the communication service utilizes Fourth Generation (4G) Long Term Evolution (LTE) technology.

5. The device of claim 1, wherein the first selected resource of the NTN includes a satellite.

6. The device of claim 5, wherein the satellite is a low earth orbit (LEO) satellite, and wherein the selecting comprises selecting the LEO satellite from amongst a plurality of LEO satellites.

7. The device of claim 1, wherein the operations further comprise:
determining a first time when the resource of the NTN is going to enter a viewing radius of an antenna of the first resource, resulting in a second determination,
wherein the selecting is further based on the second determination.

8. The device of claim 7, wherein the operations further comprise:
determining a second time when the resource of the NTN is going to depart the viewing radius of the antenna of the first resource, resulting in a third determination,
wherein the selecting is further based on the third determination.

9. The device of claim 1, wherein the selecting is based on one or more factors, and wherein the one or more factors pertain to: connection availability, carrier to noise ratio, signal strength, throughput, packet round trip delay, bit error rate, sector capacity, data link integrity, security, or any combination thereof.

10. The device of claim 1, wherein the operations further comprise:
selecting another resource of the NTN, resulting in a second selected resource of the NTN; and
provisioning a second portion of the communication service to the user equipment via the second selected resource of the NTN.

11. The device of claim 10, wherein the provisioning of the second portion of the communication service occurs subsequent to the provisioning of the first portion of the communication service.

12. The device of claim 11, wherein the selecting of the another resource of the NTN occurs prior to the provisioning of the first portion of the communication service.

13. The device of claim 1, wherein the operations further comprise:
subsequent to the provisioning of the first portion of the communication service, determining that a second amount of bandwidth available to the user equipment via the first resource of the terrestrial network is greater than a second threshold, resulting in a second determination.

14. The device of claim 13, wherein the operations further comprise:
based on the second determination, releasing the resource of the NTN to a pool of resources of the NTN.

15. The device of claim 13, wherein the first threshold and the second threshold are different.

16. A non-transitory machine-readable medium, comprising executable instructions that, when executed by a processing system including a processor, facilitate performance of operations, the operations comprising:
predicting an amount of demand for a communication service;
based on the predicting, determining that a communication bandwidth available via a first base station of a first network is unable to satisfy the amount of demand;
based on the determining, scheduling a first satellite of a constellation of satellites to provide at least a portion of the communication service, resulting in a schedule; and
providing the at least a portion of the communication service in accordance with the schedule.

17. The non-transitory machine-readable medium of claim 16, wherein the scheduling of the first satellite is based on a determination of a first arrival time of the first satellite relative to a viewing radius of an antenna associated with the first base station and a first departure time of the first satellite relative to the viewing radius of the antenna.

18. The non-transitory machine-readable medium of claim 17, wherein the scheduling of the first satellite is based on a determination of a second arrival time of a second satellite of the constellation of satellites relative to the viewing radius of the antenna associated with the first base station and a second departure time of the second satellite relative to the viewing radius of the antenna, wherein the first arrival time is different from the second arrival time and the first departure time is different from the second departure time.

19. A method, comprising:
determining, by a processing system including a processor, a respective arrival time of each satellite included in a plurality of satellites relative to a viewing radius of a first antenna associated with a first base station of a terrestrial network, resulting in a first determination;
determining, by the processing system, a respective departure time of each satellite included in the plurality of satellites relative to the viewing radius of the first antenna, resulting in a second determination;
generating, by the processing system, a forecast of demand for communication services amongst a plurality of communication devices; and
scheduling, by the processing system, a utilization of at least one satellite included in the plurality of satellites based on the first determination, the second determination, and the forecast.

20. The method of claim 19, comprising:
determining, by the processing system, a respective arrival time of each satellite included in the plurality of satellites relative to a viewing radius of a second antenna associated with a second base station of the terrestrial network, resulting in a third determination; and
determining, by the processing system, a respective departure time of each satellite included in the plurality of satellites relative to the viewing radius of the second antenna, resulting in a fourth determination,
wherein the scheduling is further based on the third determination and the fourth determination, and
wherein the at least one satellite is used in a conveyance of first data to a user equipment included in the plurality of communication devices, and
wherein the first data is less critical relative to second data that is conveyed by the first base station to the user equipment without utilizing the at least one satellite.
